(19) United States
(12) Patent Application Publication
(10) Pub. No.: US 2019/0259343 A1
(43) Pub. Date: Aug. 22, 2019

(54) IMAGE DISPLAY DEVICE AND IMAGE DISPLAY METHOD

(71) Applicant: Sharp Kabushiki Kaisha, Sakai City, Osaka (JP)

(72) Inventors: Masaaki MORIYA, Sakai City (JP); Katsuya OTOI, Sakai City (JP); Takayuki MURAI, Sakai City (JP)

(21) Appl. No.: 16/345,741

(22) PCT Filed: Oct. 3, 2017
(86) PCT No.: PCT/JP2017/035932

§ 371 Date: Apr. 29, 2019

(30) Foreign Application Priority Data
Nov. 7, 2016 (JP) 2016-216890

(51) Int. Cl. G09G 3/36; G09G 3/34

(52) U.S. Cl. CPC G09G 3/3607; G09G 2320/0271; G09G 2320/0233; G09G 3/342

(57) ABSTRACT

An image display device allowing a user to view an image with a dynamic range wider than before can be realized regardless of performance limitations of a light emitting element or a power supply. The image display device includes a glare correction unit for correcting a pixel value of a pixel around a high luminance pixel so that a gradation area, in which a luminance value gradually decreases from the high luminance pixel to a low luminance pixel, is provided. The glare correction unit includes a high luminance pixel searching unit for detecting a high luminance pixel among pixels within a predetermined range centered on a target pixel and for outputting mixing ratio data and pixel data of the high luminance pixel, and a pixel value mixing unit for correcting pixel data of the target pixel by mixing pixel data of the target pixel and the pixel data of the high luminance pixel based on the mixing ratio data.

### TECHNICAL FIELD

The following disclosure relates to an image display device and an image display method, and more particularly to a technology for expanding a dynamic range.

### BACKGROUND ART

Regarding a display device such as a liquid crystal display device or the like, in recent years, expansion of a dynamic range is strongly demanded. For example, in a liquid crystal display device configured with a transmissive liquid crystal panel and a backlight, the dynamic range expansion is realized by dividing a screen logically into a plurality of areas and performing local dimming processing for controlling a luminance of a light source for each area. In such a liquid crystal display device performing the local dimming processing, a light emitting diode (LED) is typically adopted as a light source. A light emitting luminance of the LED is controlled based on an input image in a corresponding area. Specifically, the light emitting luminance of each LED is obtained based on a maximum value or an average value of a target luminance (luminance corresponding to an input gradation value) of a pixel (sub-pixel) included in the corresponding area.

By performing the local dimming processing, for example, a light emitting luminance of LEDs of some areas can be made lower than a light emitting luminance of LEDs when the entire backlight is constantly lit with a fixed luminance without performing the local dimming processing. In this way, it is possible to further decrease a lower limit of the dynamic range. Conversely, for example, there is a case where a light emitting luminance of LEDs of some areas can be made higher than a light emitting luminance of LEDs when the entire backlight is constantly lit with a fixed luminance without performing the local dimming processing. In this way, it is possible to further increase an upper limit of the dynamic range.

Note that a liquid crystal display device that performs local dimming processing is described in, for example, Japanese Unexamined Patent Application Publication No. 2009-198530. According to the liquid crystal display device described in Japanese Unexamined Patent Application Publication No. 2009-198530, each light source can emit light with a luminance different from a luminance based on the input image, and a luminance insufficiency at the time of single area lighting is eliminated.

### CITATION LIST

### Patent Literature

PTL 1: Japanese Unexamined Patent Application Publication No. 2009-198530

### SUMMARY OF INVENTION

### Technical Problem

By performing the local dimming processing as described above, the dynamic range is expanded as compared with a configuration in which the entire backlight is constantly lit at a fixed luminance. However, increasing the upper limit of the dynamic range by the local dimming processing is limited by the following two reasons. The first reason is a reason based on the performance of a light emitting element such as an LED. Generally, a current larger than the specified amount is not able to flow through a light emitting element such as an LED. It is because supplying a current larger than the specified amount to the light emitting element leads to deterioration and destruction of the light emitting element. Therefore, even when there is availability in a current supply capability of a power supply, the power supply cannot supply a current larger than the specified amount to the light emitting element. That is, even if there is availability in the current supply capability of the power supply, it is not possible to cause the light emitting element to emit light with a luminance equal to or higher than a certain luminance. The second reason is a reason based on a power supply restriction. An upper limit value of a current that can be supplied is determined for a power supply, and there is a case where the current to be supplied to the light emitting element exceeds the upper limit value of the current which the power supply can supply, when an image with high average luminance is input to the liquid crystal display device performing the local dimming processing. In such a case, there is a need to control a brightness of the backlight of the entire screen so that the current supplied from the power supply does not exceed a predetermined upper limit value even if the light emitting element itself has a capacity margin in the performance. As described above, the upper limit of the dynamic range is not sufficiently increased due to a limitation on the performance of the light emitting element or the power supply. However, in recent years, further expansion of the dynamic range is strongly demanded.

In the following disclosure, it is an object to realize an image display device which allows a user to view an image with a dynamic range wider than before, regardless of a performance limitation of a light emitting element or a power supply.

### Solution to Problem

An image display device according to a first aspect of the present disclosure has a display unit including a plurality of pixels and displaying an image corresponding to input image data on the display unit, and includes a pixel value correction unit that corrects a pixel value of a pixel around a high luminance pixel so that a gradation area, in which a luminance value gradually decreases from the high luminance pixel toward a low luminance pixel, is provided, and a display driving unit that drives the display unit based on the corrected pixel value by the pixel value correction unit.

In a second aspect of the present disclosure, in the first aspect of the present disclosure, the pixel value correction unit sequentially selects all the pixels included in the display unit one by one as a target pixel, and corrects a pixel value of the target pixel according to a distance from the target pixel to the high luminance pixel and a pixel value of the high luminance pixel.

In a third aspect of the present disclosure, in the second aspect of the present disclosure, the pixel value correction unit includes a high luminance pixel searching unit for detecting, as a high luminance pixel, a pixel having a relatively high luminance value determined according to a predetermined determination criterion from among a plurality of pixels within a predetermined range centered on the target pixel based on the input image data, and outputting a mixing ratio for use in correcting the pixel value of the target pixel and a pixel value of the high luminance pixel based on the input image data, and a pixel value mixing unit for correcting the pixel value of the target pixel by mixing the pixel value of the target pixel based on the input image data and the pixel value of the high luminance pixel output from the high luminance pixel searching unit according to the mixing ratio output from the high luminance pixel searching unit, the mixing ratio is set to a larger value as the distance from the target pixel to the high luminance pixel is shorter, and the pixel value mixing unit corrects the pixel value of the target pixel so that a contributory portion of the pixel value of the high luminance pixel output from the high luminance pixel searching unit increases as the mixing ratio output from the high luminance pixel searching unit is larger.

In a fourth aspect of the present disclosure, in the third aspect of the present disclosure, the high luminance pixel searching unit sequentially selects the plurality of pixels within the predetermined range centered on the target pixel one by one as a search pixel, obtains a luminance value of the search pixel based on a pixel value of a search pixel based on the input image data, and also obtains an assumed mixing ratio which is a mixing ratio in a case where it is assumed that the search pixel is determined as a high luminance pixel, and detects a search pixel, in which a product value of the luminance value and the assumed mixing ratio becomes the largest value, as a high luminance pixel, and outputs the assumed mixing ratio corresponding to the search pixel as a mixing ratio for use in correcting the pixel value of the target pixel.

In a fifth aspect of the present disclosure, in the fourth aspect of the present disclosure, the high luminance pixel searching unit obtains the assumed mixing ratio by using a mixing ratio calculation function prepared in advance with a value corresponding to a distance from the target pixel to the search pixel as an argument.

In a sixth aspect of the present disclosure, in the fifth aspect of the present disclosure, the mixing ratio calculation function is represented by the following expression.

f(x)=1−x (when 0≤x≤1)

f(x)=0 (when 1<x) [Expression 1]

Where x is a value determined according to the distance from the target pixel to the search pixel.

In a seventh aspect of the present disclosure, in the fifth aspect of the present disclosure, the mixing ratio calculation function is represented by the following expression.

$$\begin{matrix}[ Expression 2 ] & \\ f ( x ) = a \cdot exp \{ - \frac{{( x - b )}^{2}}{2 {c}^{2}} \} & \end{matrix}$$

Where x is a value determined according to the distance from the target pixel to the search pixel, and a, b, and c are constants defining a shape of a curve representing the mixing ratio calculation function.

In an eighth aspect of the present disclosure, in the fourth aspect of the present disclosure, the high luminance pixel searching unit obtains the assumed mixing ratio corresponding to the search pixel, only for the search pixels in which a luminance value is larger than a predetermined first threshold value.

In a ninth aspect of the present disclosure, in the eighth aspect of the present disclosure, the high luminance pixel searching unit obtains the assumed mixing ratio according to the following expression, in accordance with a magnitude relationship between a predetermined second threshold value set to a value larger than the first threshold value and the luminance value of the search pixel, by using a mixing ratio calculation function f prepared in advance with a value determined according to a distance from the target pixel to the search pixel as an argument.

$$\begin{matrix}[ Expression 3 ] & \\ R = f ( \frac{D}{D\_MAX} ) ( when L \geq TH 2 ) & \\ R = f ( \frac{D}{D\_MAX} \cdot \frac{TH 2 - TH 1}{L - TH 1} ) ( when L < TH 2 ) & \end{matrix}$$

Where R is the assumed mixing ratio, D is the distance from the target pixel to the search pixel, D_MAX is the maximum distance from the target pixel to a pixel that can be a search pixel, L is the luminance value of the search pixel, TH1 is the first threshold value, and TH2 is the second threshold value.

In a tenth aspect of the present disclosure, in the eighth aspect of the present disclosure, the high luminance pixel searching unit obtains the assumed mixing ratio according to the following expression by using a mixing ratio calculation function f prepared in advance with a value determined according to a distance from the target pixel to the search pixel as an argument.

$$\begin{matrix}[ Expression 4 ] \\ R = f ( \frac{D}{D\_MAX} ) ( when L \geq TH 2 )\end{matrix}$$

Where R is the assumed mixing ratio, D is the distance from the target pixel to the search pixel, and D_MAX is the maximum distance from the target pixel to a pixel that can be a search pixel.

In an eleventh aspect of the present disclosure, in the fourth aspect of the present disclosure, the high luminance pixel searching unit obtains the assumed mixing ratio corresponding to each search pixel, for all the search pixels.

In a twelfth aspect of the present disclosure, in the first aspect of the present disclosure, the image display device further includes a backlight having one or more light sources, and a light source control unit that controls light emitting luminance of the one or more light sources, in which the light source control unit uniformly controls the light emitting luminance of the one or more light sources.

In a thirteenth aspect of the present disclosure, in the first aspect of the present disclosure, the image display device further includes a backlight having a plurality of light sources, and a light source control unit that controls light emitting luminance of the plurality of light sources, in which the display unit is logically divided into a plurality of areas, in which each of the light sources is provided so as to correspond to any of the plurality of areas, and in which the light source control unit controls the light emitting luminance of the plurality of light sources for each area.

An image display method according to a fourteenth aspect of the present disclosure for displaying an image corresponding to input image data on a display unit including a plurality of pixels includes a pixel value correction step of correcting a pixel value of a pixel around a high luminance pixel to a value larger than a value based on the input image data so that a gradation area, in which a luminance value gradually decreases from the high luminance pixel toward a low luminance pixel, is provided, and a display driving step of driving the display unit based on the corrected pixel value obtained in the pixel value correction step.

### Advantageous Effects of Invention

According to the first aspect of the present disclosure, the gradation area in which the luminance value gradually decreases from the high luminance pixel is added around the high luminance pixel. As a result, a human feels the brightness of the high luminance pixel (high luminance area) stronger than before by a glare optical illusion. That is, an upper limit of the dynamic range is increased in a pseudo manner. Here, since the addition of the gradation area is performed by correcting the pixel values of the pixels around the high luminance pixel, the performance of the light emitting element (light source) or the power supply is not limited differently from before. In this way, an image display device capable of allowing a user to view an image with a wider dynamic range than before can be realized regardless of performance limitations of a light emitting element or a power supply.

According to the second to fourth aspects of the present disclosure, the same effect as the first aspect of the present disclosure can be obtained.

According to the fifth aspect of the present disclosure, it is possible to change the luminance value as desired in the gradation area by appropriately defining the mixing ratio calculation function.

According to the sixth aspect of the present disclosure, it is possible to add a gradation area in which the luminance value gradually decreases linearly from the high luminance pixel toward the surrounding to around the high luminance pixel.

According to the seventh aspect of the present disclosure, it is possible to add a gradation area in which the luminance value decreases in a Gaussian curve shape from the high luminance pixel toward the surrounding to around the high luminance pixel.

According to the eighth aspect of the present disclosure, an unnecessary addition of the gradation area can be reduced.

According to the ninth aspect of the present disclosure, the size of the gradation area to be added changes in accordance with the mutual magnitude relationship among the luminance value of the high luminance pixel, the second threshold value, and the first threshold value. That is, it is possible to add a gradation area in which the area size changes smoothly in accordance with the luminance value of the high luminance pixel from a gradation area of a relatively wide area to a gradation area of zero width (that is, a state in which a gradation area is not added). Thereby, giving a sense of discomfort to a viewer due to the addition of the gradation area is suppressed.

According to the tenth aspect of the present disclosure, it is possible to increase the upper limit of the dynamic range in a pseudo manner just by providing a relatively simple circuit.

According to the eleventh aspect of the present disclosure, it is possible to increase the upper limit of the dynamic range in a pseudo manner just by providing a simple circuit.

According to the twelfth aspect of the present disclosure, there are cases where it is possible to reduce the light emitting luminance of the light source by a dimming processing, so that low power consumption can be achieved. In addition to increasing the upper limit of the dynamic range in a pseudo manner, it is also possible to lower the lower limit of the dynamic range by remarkably lowering the light emitting luminance of the light source in a low gradation portion. Further, since there is no need to logically divide the screen into a plurality of areas unlike the case where the local dimming processing is performed, it is possible to simplify the circuits used for various operations of the dimming processing.

According to the thirteenth aspect of the present disclosure, since the light emitting luminance of the plurality of light sources can be independently controlled, low power consumption can be achieved. In addition to increasing the upper limit of the dynamic range in a pseudo manner, it is also possible to lower the lower limit of the dynamic range by remarkably lowering the light emitting luminance of the light source in the low gradation portion.

According to the fourteenth aspect of the present disclosure, the same effect as the first aspect of the present disclosure can be performed in the image display method.

### BRIEF DESCRIPTION OF DRAWINGS

FIG. 1 is a diagram for explaining the concept of the present disclosure.

FIG. 2 is a block diagram showing an entire configuration of a liquid crystal display device according to an embodiment of the present disclosure.

FIG. 3 is a diagram for explaining areas in the above embodiment.

FIG. 4 is a diagram showing a configuration of a backlight in the above embodiment.

FIG. 5 is a block diagram showing a configuration of a display control circuit in the above embodiment.

FIG. 6 is a flowchart for explaining an example of a procedure of local dimming processing in the above embodiment.

FIG. 7 is a block diagram showing a detailed functional configuration of a glare correction unit in the display control circuit in the above embodiment.

FIG. 8 is a flowchart showing a procedure of high luminance pixel search processing in the above embodiment.

FIG. 9 is a diagram for explaining a function f(x) used for calculating a mixing ratio (assumed mixing ratio) in the above embodiment.

FIG. 10 is a diagram for explaining a setting of a value of a mixing ratio (assumed mixing ratio) in the above embodiment.

FIG. 11 is a diagram for explaining an effect in the above embodiment.

FIG. 12 is a diagram for explaining an effect in the above embodiment.

FIG. 13 is a diagram for explaining an effect in the above embodiment.

FIG. 14 is a diagram for explaining an effect in the above embodiment.

FIG. 15 is a diagram for explaining an effect in the above embodiment.

FIG. 16 is a diagram for explaining an effect in the above embodiment.

FIG. 17 is a diagram for explaining an effect in the above embodiment.

FIG. 18 is a flowchart for explaining an example of a procedure of the dimming processing in a first modification example of the above embodiment.

FIG. 19 is a block diagram showing a configuration of the display control circuit in a second modification example of the above embodiment.

FIG. 20 is a diagram for explaining a function f(x) used for calculating a mixing ratio (assumed mixing ratio) in a third modification example of the above embodiment.

FIG. 21 is a flowchart showing a procedure of high luminance pixel search processing in a fourth modification example of the above embodiment.

FIG. 22 is a flowchart showing a procedure of high luminance pixel search processing in a fifth modification example of the above embodiment.

### DESCRIPTION OF EMBODIMENTS

### 1. Introduction

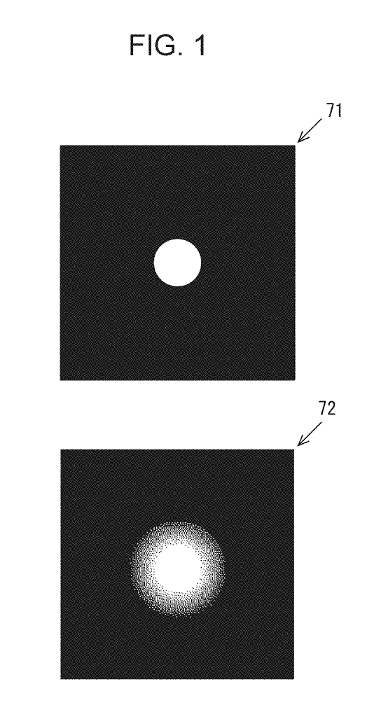

Before explaining the embodiment, the concept of the present disclosure will be described. A phenomenon called “glare optical illusion” is known as one of an optical illusion phenomenon on brightness. The glare optical illusion is a phenomenon that “in a case where a bright area exists in a dark background, a person feels the bright area brighter and dazzling when a gradation area exists which gradually becomes dark from the bright area to the dark area compared with when such a gradation area does not exist. Considering such a glare optical illusion, in a liquid crystal display device according to the following embodiment, processing, in which an area having a certain brightness or more is detected from an input image and a gradation area is added around the area (hereinafter, it is referred to as “glare correction processing”), is performed. Specifically, when the input image is an image as indicated by a reference numeral 71 in FIG. 1 (an image having a high luminance area only in the central portion), processing for adding a gradation area is performed to the input image as in an image indicated by a reference numeral 72 in FIG. 1. By displaying an image to which such a gradation area is added, a person feels the high luminance area in the central portion brighter and dazzling as compared with a case when the input image is displayed as it is.

Hereinafter, an embodiment of the present disclosure will be described with reference to the accompanying drawings.

### 2. Entire Configuration and Operation Outline

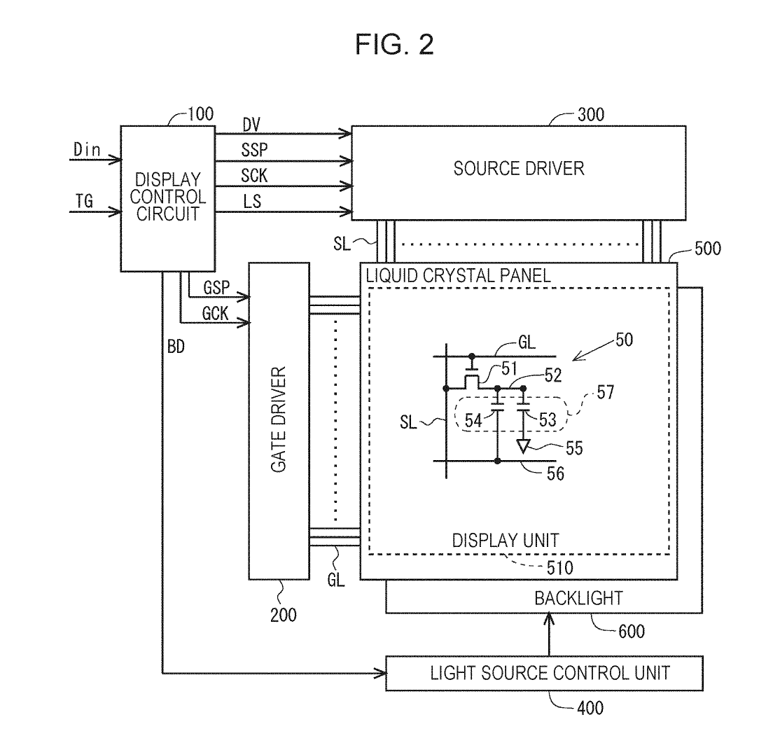

FIG. 2 is a block diagram showing an entire configuration of a liquid crystal display device according to an embodiment of the present disclosure. This liquid crystal display device is configured with a display control circuit 100, a gate driver (scan signal line driving circuit) 200, a source driver (video signal line driving circuit) 300, a light source control unit 400, a liquid crystal panel 500 and a backlight 600. The liquid crystal panel 500 includes a display unit 510 for displaying an image. Note that the gate driver 200 or the source driver 300 or both may be provided in the liquid crystal panel 500.

Referring to FIG. 2, a plurality of source bus lines (video signal lines) SL and a plurality of gate bus lines (scan signal lines) GL are disposed in the display unit 510. A pixel forming unit 50 for forming a sub-pixel is provided corresponding to each intersection of the plurality of source bus lines SL and the plurality of gate bus lines GL. That is, the display unit 510 includes a plurality of pixel forming units 50. The plurality of pixel forming units 50 are disposed in a matrix shape and constitutes a pixel matrix. Each pixel forming unit 50 includes a thin film transistor (TFT) 51 which is a switching element having a gate terminal connected to a gate bus line GL passing through a corresponding intersection and a source terminal connected to a source bus line SL passing through a corresponding intersection, a pixel electrode 52 connected to a drain terminal of the TFT 51, a common electrode 55 and an auxiliary capacity electrode 56 which are commonly provided in the plurality of pixel forming units 50, a liquid crystal capacity 53 formed with the pixel electrode 52 and the common electrode 55, and an auxiliary capacity 54 formed with the pixel electrode 52 and the auxiliary capacity electrode 56. A pixel capacity 57 is configured with the liquid crystal capacity 53 and the auxiliary capacity 54. Note that only the components corresponding to one pixel forming unit 50 are shown in the display unit 510 in FIG. 2.

In the present embodiment, one pixel is configured with a red sub-pixel, a green sub-pixel, and a blue sub-pixel. Therefore, pixel data described later is configured with data indicating a gradation value of red, data indicating a gradation value of green, and data indicating a gradation value of blue. However, a pixel configuration is not limited to such a configuration.

As the TFT 51 in the display unit 510, for example, an oxide TFT (a thin film transistor using an oxide semiconductor for a channel layer) can be adopted. More specifically, a TFT in which a channel layer is formed with In—Ga—Zn—O (indium gallium zinc oxide) which is an oxide semiconductor containing indium (In), gallium (Ga), zinc (Zn), and oxygen (O) as base components (hereinafter referred to as “In—Ga—Zn—O-TFT”), can be adopted as the TFT 51. By adopting such an In—Ga—Zn—O-TFT, effects such as high resolution and low power consumption can be obtained. Further, a transistor using an oxide semiconductor other than In—Ga—Zn—O (indium gallium zinc oxide) as a channel layer can also be adopted. For example, the same effect can be obtained when the transistor using an oxide semiconductor containing at least one of indium, gallium, zinc, copper (Cu), silicon (Si), tin (Sn), aluminum (Al), calcium (Ca), germanium (Ge), and lead (Pb) is used for the channel layer. Note that the present disclosure does not exclude the use of TFTs other than the oxide TFT.

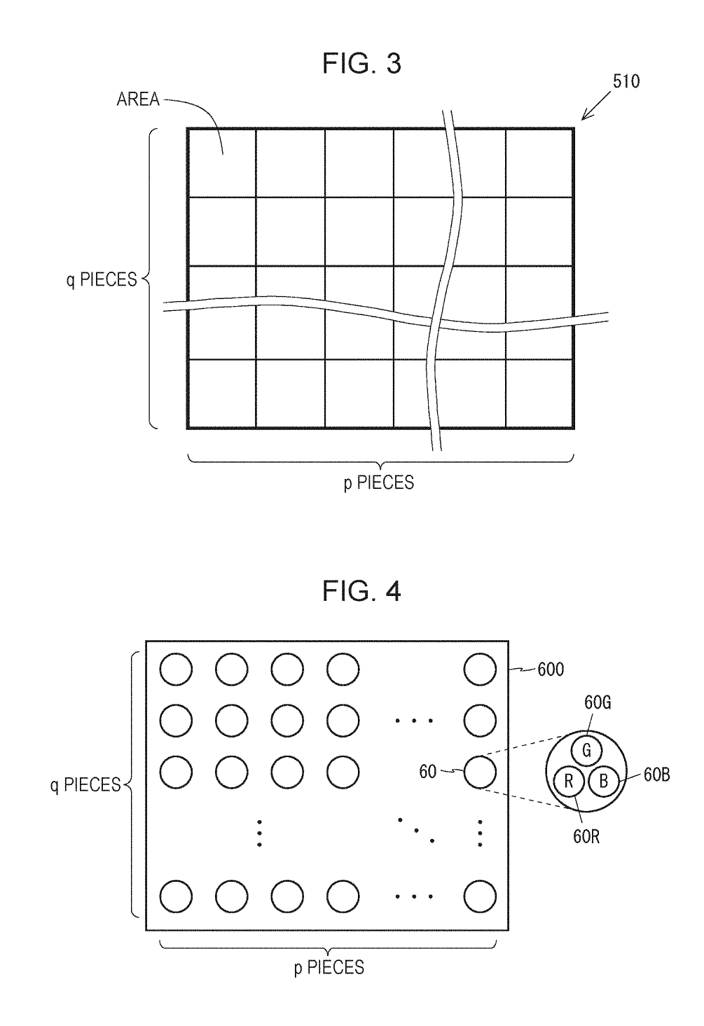

In the liquid crystal display device according to the present embodiment, the above-described local dimming processing is performed. Therefore, the display unit 510 is logically divided into (p×q) areas as shown in FIG. 3, and the control of luminance (light emitting luminance) of a light source is performed for each area. The backlight 600 includes (p×q) pieces of LED units 60 as shown in FIG. 4. The p pieces of the LED units 60 are disposed in an extending direction of the gate bus line GL, and the q pieces of the LED units 60 are disposed in an extending direction of the source bus line SL. As described above, the LED unit 60 is provided for each area. However, a plurality of LED units 60 may be provided for one area. Although the configuration of each LED unit 60 is not particularly limited, in the present embodiment, it is assumed that each LED unit 60 is configured with one red LED 60R, one green LED 60G and one blue LED 60B (see FIG. 4).

Next, an operation of the components shown in FIG. 2 will be described. The display control circuit 100 receives input image data Din sent from the outside and a timing signal group TG such as a horizontal synchronization signal and a vertical synchronization signal, and outputs a digital video signal DV, a gate start pulse signal GSP and a gate clock signal GCK for controlling an operation of the gate driver 200, a data start pulse signal SSP and a data clock signal SCK and a latch strobe signal LS for controlling an operation of the source driver 300, and light emitting luminance data BD for controlling an operation of the light source control unit 400.

The gate driver 200 repeats applying an active scan signal to each gate bus line GL with one vertical scan period as a cycle based on the gate start pulse signal GSP and the gate clock signal GCK sent from the display control circuit 100.

The source driver 300 receives the digital video signal DV, the data start pulse signal SSP, the data clock signal SCK, and the latch strobe signal LS sent from the display control circuit 100, and applies a driving video signal to each source bus line SL. At this time, in the source driver 300, the digital video signal DV is sequentially retained at the timing when the pulse of the data clock signal SCK is generated. Then, at the timing when the pulse of the latch strobe signal LS is generated, the retained digital video signal DV is converted into an analog voltage. The converted analog voltage is simultaneously applied to all source bus lines SL as the driving video signals.

The light source control unit 400 appropriately controls the luminance (light emitting luminance) of the LEDs (the red LED 60R, the green LED 60G, and the blue LED 60B) in the backlight 600 based on light emitting luminance data BD sent from the display control circuit 100. Thereby, a back surface of the liquid crystal panel 500 is irradiated with light of the backlight from the backlight 600. Note that in the present embodiment, the local dimming processing is performed, and the local dimming processing will be described later.

As described above, an image corresponding to the input image data Din sent from the outside is displayed on the display unit 510 by applying the scan signal to each gate bus line GL, applying the driving video signal to each source bus line SL, and appropriately controlling the luminance of the LEDs in the backlight 600.

Note that in the present embodiment, a display driving unit is realized by the gate driver 200 and the source driver 300.

### 3. Display Control Circuit and Local Dimming Processing

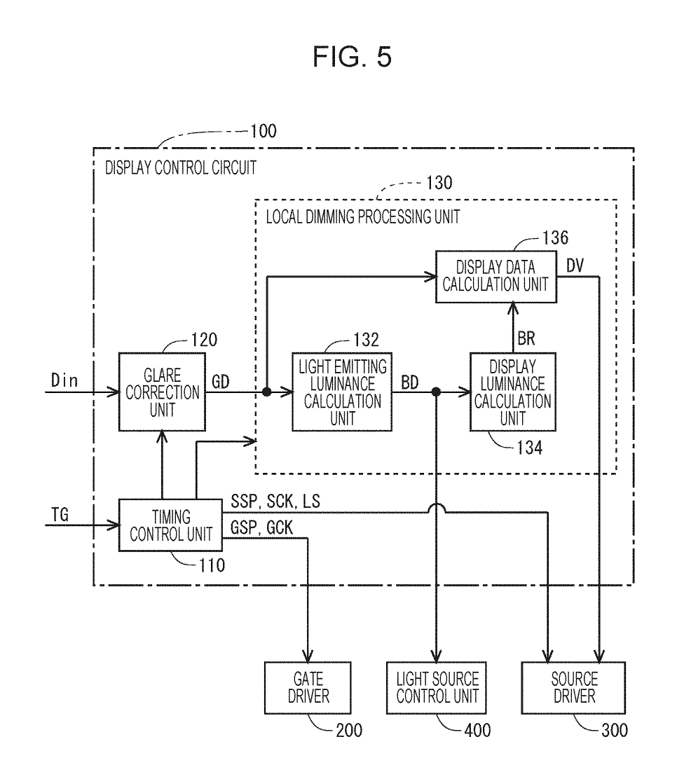

FIG. 5 is a block diagram showing a configuration of the display control circuit 100 in the present embodiment. The display control circuit 100 is configured with a timing control unit 110, a glare correction unit 120, and a local dimming processing unit 130. Note that in the present embodiment, a pixel value correction unit is realized by the glare correction unit 120.

The timing control unit 110 receives the timing signal group TG sent from the outside, controls an operation of the glare correction unit 120 and the local dimming processing unit 130, outputs the gate start pulse signal GSP and the gate clock signal GCK to the gate driver 200, and outputs the data start pulse signal SSP, the data clock signal SCK, and the latch strobe signal LS to the source driver 300.

All the pixels included in the display unit 510 are sequentially selected one by one as a target pixel and based on the input image data Din, the glare correction unit 120 detects a high luminance pixel from a plurality of pixels within a predetermined range centered on the target pixel, and corrects a pixel value of the target pixel according to a distance from the target pixel to the high luminance pixel and a pixel value of the high luminance pixel in order to provide a gradation area in which a luminance value gradually decreases from the high luminance pixel to the low luminance pixel. In this manner, the glare correction unit 120 performs glare correction processing on the input image data Din sent from the outside. Then, the glare correction unit 120 outputs glare correction data GD, which is data after the glare correction processing, to the local dimming processing unit 130. The input image data Din includes an R image (red image), a G image (green image), and a B image (blue image). Accordingly, the glare correction data GD also includes the R image, the G image, and the B image. The glare correction processing will be described in more detail later.

The local dimming processing unit 130 performs the local dimming processing based on the glare correction data GD. At that time, the local dimming processing unit 130 obtains a light emitting luminance of the red LED 60R corresponding to the area for each of the (p×q) pieces of areas (see FIG. 3) based on the R image in the area. Similarly, the light emitting luminance of the green LED 60G is determined based on the G image in the area, and the light emitting luminance of the blue LED 60B is determined based on the B image in the area. In this way, the local dimming processing unit 130 obtains the light emitting luminance of all the LEDs in the backlight 600, and outputs the light emitting luminance data BD representing the obtained light emitting luminance to the light source control unit 400. Further, the local dimming processing unit 130 obtains a luminance of the light of the backlight light in all the sub-pixels (the luminance means “luminance obtained by displaying”, hereinafter referred to as “display luminance”) based on the light emitting luminance data BD, and obtains a target light transmittance in all the sub-pixels based on the glare correction data GD and the display luminance. Then, the local dimming processing unit 130 outputs the digital video signal DV corresponding to the obtained light transmittance to the source driver 300. Hereinafter, the configuration of the local dimming processing unit 130 and the procedure of the local dimming processing will be described in more detail.

As shown in FIG. 5, the local dimming processing unit 130 includes a light emitting luminance calculation unit 132, a display luminance calculation unit 134, and a display data calculation unit 136. The light emitting luminance calculation unit 132 divides an image represented by the glare correction data GD (hereinafter referred to as “image after the glare correction”) into images of a plurality of areas, and obtains the light emitting luminance of the LED corresponding to each area based on the image after the glare correction. For each color, the light emitting luminance is determined based on the maximum value of the gradation value of the sub-pixel in the area. However, the light emitting luminance may be determined based on a value obtained by calculating a weighted average of an average value of the gradation values of the sub-pixels in the area or the maximum value of the gradation values of the sub-pixels in the area, and the average value. The light emitting luminance calculation unit 132 outputs the light emitting luminance data BD representing the obtained light emitting luminance. The display luminance calculation unit 134 obtains the display luminance of all the sub-pixels included in the display unit 510 based on the light emitting luminance data BD output from the light emitting luminance calculation unit 132. The display luminance calculation unit 134 outputs display luminance data BR representing the obtained display luminance. Based on the glare correction data GD and the display luminance data BR, the display data calculation unit 136 generates display data representing the target light transmittance in all the sub-pixels included in the display unit 510. The display data is output from the display data calculation unit 136 as the digital video signal DV. Note that the target light transmittance can be obtained by dividing the luminance corresponding to the gradation value indicated by the glare correction data GD, by the display luminance indicated by the display luminance data BR.

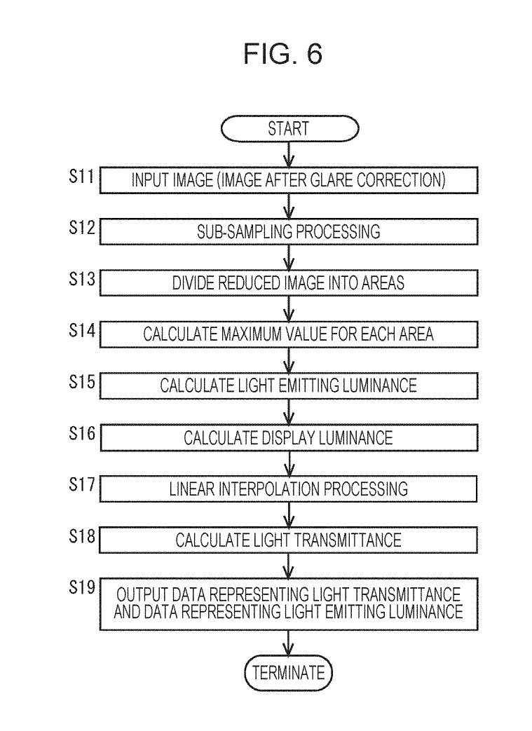

Here, an example of a procedure of the local dimming processing will be described with reference to FIG. 6. Note that in the present embodiment, the local dimming processing is performed for each color of R, G, and B. Further, it is assumed that “m and n are integers greater than or equal to two, p and q are integers greater than or equal to one, and at least one of p and q is an integer greater than or equal to two”. For example, when both p and q are integers greater than or equal to two, the luminance of the LED in the backlight 600 is controlled for each divided area in a state where the area is logically divided in both the vertical direction and the horizontal direction. Such control is referred to as “two-dimensional (2D) dimming”. When either one of p and q is one, the luminance of the LED in the backlight 600 is controlled for each divided area in a state where the area is logically divided only in the vertical direction or the horizontal direction. Such control is referred to as “one-dimensional (1D) dimming”.

First, the image after the glare correction (glare correction data GD) is input to the local dimming processing unit 130 (step S11). (m×n) pieces of gradation value data are included in the glare correction data GD for one screen. Next, the local dimming processing unit 130 performs sub-sampling processing (averaging processing) on the glare correction data GD and obtains a reduced image configured with (sp×sq) pieces of gradation value data (s is an integer greater than or equal to two) (step S12). Next, the local dimming processing unit 130 divides the reduced image into data of (p×q) pieces of areas (step S13). (s×s) pieces of gradation value data are included in the data of each area. Next, the local dimming processing unit 130 obtains the maximum value of the gradation value in the area for each of the (p×q) pieces of areas (step S14). Next, based on the maximum value obtained in step S14, the local dimming processing unit 130 obtains (p×q) pieces of light emitting luminance which is a luminance at the time of a light emitting of a LED corresponding to each area (step S15).

Next, the local dimming processing unit 130 obtains (tp×tq) pieces of display luminance (t is an integer greater than or equal to two) based on the (p×q) pieces of the light emitting luminance obtained in step S15 (step S16). Next, the local dimming processing unit 130 obtains the display luminance data BR representing the display luminance in (m×n) pieces of sub-pixels by performing linear interpolation processing on the (tp×tq) pieces of display luminance (Step S17). The display luminance data BR represents a luminance of light incident on the (m×n) pieces of sub-pixels when all the LEDs of the target color emit light with the light emitting luminance obtained in step S15. Next, the local dimming processing unit 130 obtains the light transmittance of the (m×n) pieces of the sub-pixels by dividing the luminance corresponding to the gradation values of (m×n) pieces of the sub-pixels included in the image after the glare correction by the (m×n) pieces of the display luminance included in the display luminance data BR (step S18). Lastly, the local dimming processing unit 130 outputs the digital video signal DV corresponding to the light transmittance obtained in step S18 and the light emitting luminance data BD for causing the LED corresponding to each area to emit the light with the light emitting luminance obtained in step S15 (step S19).

Note that it is described on the premise that the backlight 600 is configured with the LED unit 60 including the red LED 60R, the green LED 60G, and the blue LED 60B. However, even when the backlight 600 is configured with a white LED, the local dimming processing as described above can be performed. In this case, for example, after a Y image (luminance image) is generated based on the R image, the G image, and the B image, the processing of steps S12 to S17 may be performed on the Y image, and the processing of step S18 may be performed on a combination of each of the three color images and the Y image.

### 4. Glare Correction Processing

Next, a configuration of a glare correction unit 120 and glare correction processing will be described in detail.

### <4.1 Configuration of Glare Correction Unit>

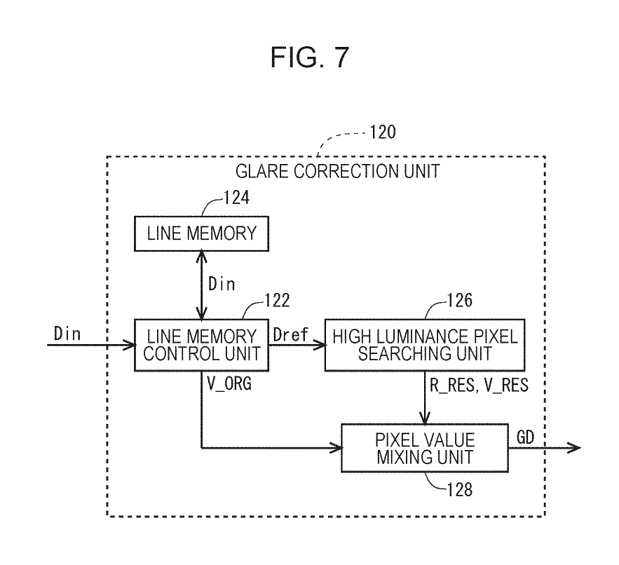

FIG. 7 is a block diagram showing a detailed functional configuration of the glare correction unit 120 in the display control circuit 100. As shown in FIG. 7, the glare correction unit 120 includes a line memory control unit 122, a line memory 124, a high luminance pixel searching unit 126, and a pixel value mixing unit 128.

In the glare correction processing, all the pixels included in the display unit 510 are sequentially selected one by one as a target pixel and the processing is performed. When processing is performed on one target pixel, data of pixels within a predetermined range centered on the target pixel is used as reference data. Therefore, the line memory control unit 122 appropriately saves the input image data Din in the line memory 124. Further, when processing is performed on one target pixel, the line memory control unit 122 provides reference data Dref used for the processing to the high luminance pixel searching unit 126, and also provides pixel data of the target pixel V_ORG to the pixel value mixing unit 128.

The high luminance pixel searching unit 126 searches for a high luminance pixel from a plurality of pixels within the predetermined range centered on the target pixel based on the reference data Dref. Searching for a high luminance pixel is performed according to a predetermined determination criterion as described later. The high luminance pixel searching unit 126 also obtains mixing ratio data R_RES for correcting the pixel data of the target pixel V_ORG according to a distance between the high luminance pixel detected by the search and the target pixel. Then, the high luminance pixel searching unit 126 provides the obtained mixing ratio data R_RES and the pixel data of the high luminance pixel V_RES detected by the search (this data is one of the reference data Dref) to the pixel value mixing unit 128. Hereinafter, the processing performed by the high luminance pixel searching unit 126 is referred to as “high luminance pixel search processing”.

The pixel value mixing unit 128 corrects the pixel data of the target pixel V_ORG based on the mixing ratio data R_RES and the pixel data of the high luminance pixel V_RES. More specifically, the pixel value mixing unit 128 mixes gradation values of the three colors included in the pixel data of the target pixel V_ORG and gradation values of the three colors included in the pixel data of the high luminance pixel V_RES according to a ratio indicated by the mixing ratio data R_RES for each color. Then, data indicating the gradation values of the three colors obtained by the mixing is output from the pixel value mixing unit 128 as the glare correction data GD.

Regarding the mixing (correction of the pixel data of the target pixel V_ORG) in the pixel value mixing unit 128, more specifically, the glare correction data GD is obtained by the following equation (1).

GD=V_RES·R_RES+V_ORG(1−R_RES) (1)

For example, it is assumed that the pixel data of the target pixel V_ORG is “(R, G, B)=(10, 20, 30)” and the pixel data of the high luminance pixel V_RES is “(R, G, B)=(220, 250, 200)”, and the mixing ratio data R_RES is “0.2”.

In this case, the glare correction data GD (gradation value) of each color of the target pixel is obtained as follows.

R=220×0.2+10(1−0.2)=52

G=250×0.2+20(1−0.2)=66

B=200×0.2+30(1−0.2)=64

As described above, in the pixel value mixing unit 128, the pixel value of the target pixel is corrected so that a contribution of the pixel value of the high luminance pixel (value of the pixel data V_RES) increases as the mixing ratio (value of the mixing ratio data R_RES output from the high luminance pixel searching unit 126) increases.

Note that depending on the target pixel, some high luminance pixels are not detected in the high luminance pixel search processing. In this case, the value of the mixing ratio data R_RES and the value of the pixel data of the high luminance pixel V_RES given to the pixel value mixing unit 128 for correcting the pixel data of the target pixel V_ORG are both zero. Therefore, as can be seen from the above expression (1), for the target pixel, the original gradation value is not corrected and the original gradation value data becomes the glare correction data GD as it is.

### <4.2 High Luminance Pixel Search Processing>

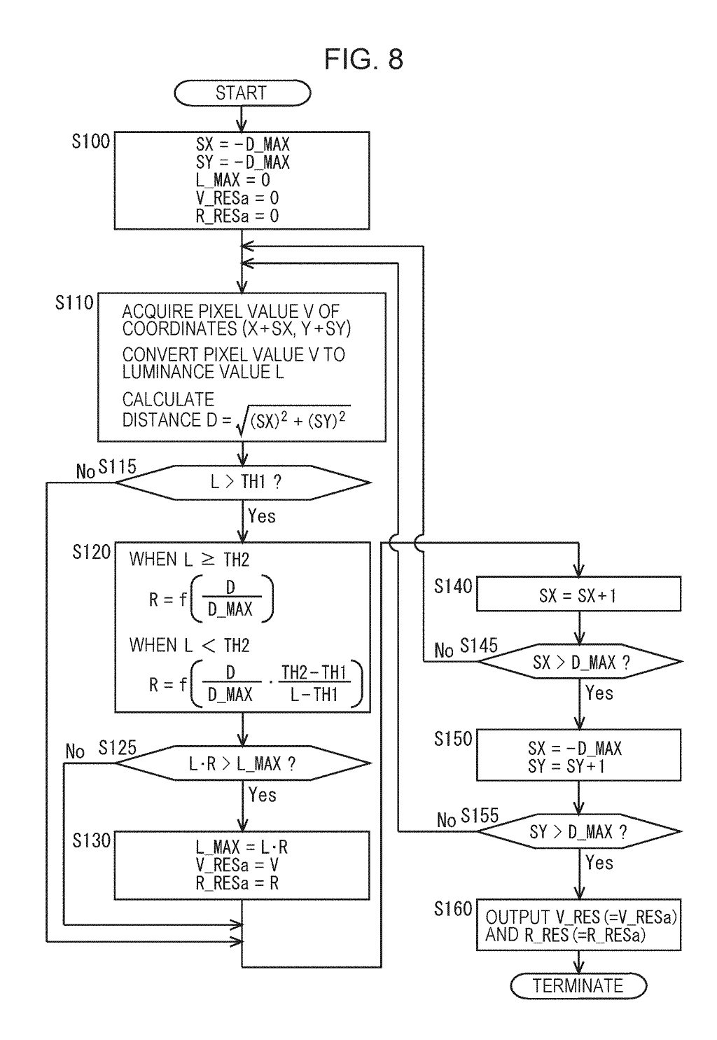

Next, the processing (high luminance pixel search processing) performed by the high luminance pixel searching unit 126 will be described in detail. FIG. 8 is a flowchart showing a procedure of the high luminance pixel search processing. As described above, in the glare correction processing, all the pixels included in the display unit 510 are sequentially selected one by one as a target pixel and the processing is performed. Accordingly, all the pixels included in the display unit 510 are sequentially selected one by one as a target pixel and processing in steps S100 to S160 shown in FIG. 8 are performed. In the following description, the coordinate of the target pixel is (X, Y).

In the high luminance pixel search processing, the following variables are used. As described above, the high luminance pixel searching is performed from among the plurality of pixels within the predetermined range centered on the target pixel and hereinafter, the pixel being searched (pixel being processed) is referred to as “search pixel”.

SX: a relative coordinate of an X coordinate of a search pixel with reference to the target pixel

SY: a relative coordinate of a Y coordinate of a search pixel with reference to the target pixel

D_MAX: a value for specifying a range to search for a high luminance pixel

R: a value of a mixing ratio (assumed mixing ratio) obtained by a function f(x) described later

L_MAX: a value representing the maximum value of a product of a variable R and a luminance value of a search pixel

V_RESa: a candidate value of the pixel data of the high luminance pixel V_RES

R_RESa: a candidate value of mixing ratio data R_RES

Note that it is assumed that a desired value is previously set in a variable D_MAX.

After the start of the high luminance pixel search processing, firstly, an initial value set is performed with variables (step S100). Specifically, a negative value of the variable D_MAX is assigned to the variable SX, a negative value of the variable D_MAX is assigned to the variable SY, zero is assigned to the variable L_MAX, zero is assigned to the variable V_RESa, and zero is assigned to the variable R_RESa. Note that the variable V_RESa can store three gradation values (red gradation value, green gradation value, and blue gradation value), and in step S100, all the gradation values of these colors are set to zero. After the end of step S100, the pixels included in a range, in which a distance from the target pixel is equal to or less than a value (distance) of the variable D_MAX in both an X axis direction and a Y axis direction, are sequentially selected one by one as a search pixel and the following steps S110 to S130 are performed.

In step S110, data on the search pixel is acquired. More specifically, acquisition of a pixel value V of a coordinates (X+SX, Y+SY) (pixel value of the search pixel), conversion from the acquired pixel value V to a luminance value L, and calculation of a distance D from the target pixel to the search pixel, are performed. Note that the distance D is a positive square root of a sum of a square of the value of the variable SX and a square of the value of the variable SY.

Here, the conversion from the pixel value V to the luminance value L will be described. As described above, pixel data is configured with data indicating a gradation value of red, data indicating a gradation value of green, and data indicating a gradation value of blue. Therefore, the pixel value V of the search pixel includes a red gradation value, a green gradation value, and a blue gradation value. In the present embodiment, one luminance value L is obtained from these three gradation values. When the gradation value of red is represented by R, the gradation value of green is represented by G, and the gradation value of blue is represented by B, the luminance value L is obtained by the following equation (2). However, the following equation (2) is an example, and the luminance value L may be obtained by another expression.

L=(77×R+150×G+27×B)/256 (2)

For example, with respect to the pixel value V of the search pixel, it is assumed that the red gradation value is 100, the green gradation value is 10, and the blue gradation value is 50. In this case, the luminance value L is obtained as follows.

L=(77×100+150×10+27×50)/256=41

After acquiring data on the search pixel, in step S115, it is determined whether or not the luminance value L obtained in step S110 is larger than a first threshold value TH1. As a result of the determination, if the luminance value L is larger than the first threshold value TH1, the processing proceeds to step S120. On the other hand, if the luminance value L is equal to or less than the first threshold value TH1, the processing proceeds to step S140.

In step S120, a value is set for the variable R according to the magnitude of the luminance value L. Specifically, if the luminance value L is equal to or larger than a second threshold value TH2, a value of the function f(D/D_MAX) is assigned to the variable R, and if the luminance value L is less than the second threshold value TH2, a value of the function f((D/D_MAX)·((TH2−TH1)/(L−TH))) is assigned to the variable R. In this manner, a value is set for the variable R according to the magnitude relationship between the second threshold value TH2 and the luminance value L of the search pixel. Note that the second threshold value TH2 is preset to a value larger than the first threshold value TH1.

The value of the variable R obtained in step S120 represents an assumed mixing ratio which is a mixing ratio in a case where it is assumed that finally, the search pixel is determined as a high luminance pixel (hereinafter, “variable R” is represented as “assumed mixing ratio R”). Note that the mixing ratio indicates a degree (proportion) that the target pixel (upon mixing in the pixel value mixing unit 128) is affected by the luminance of the high luminance pixel in a case where it is assumed that a gradation area extends from the high luminance pixel and the target pixel is included in the gradation area. Further, in step S120, after the assumed mixing ratio R corresponding to each search pixel whose luminance value L is equal to or larger than the first threshold value TH1 is calculated, the data of the assumed mixing ratio R corresponding to the search pixel finally detected as a high luminance pixel is output as the mixing ratio data R_RES described above in step S160 described later.

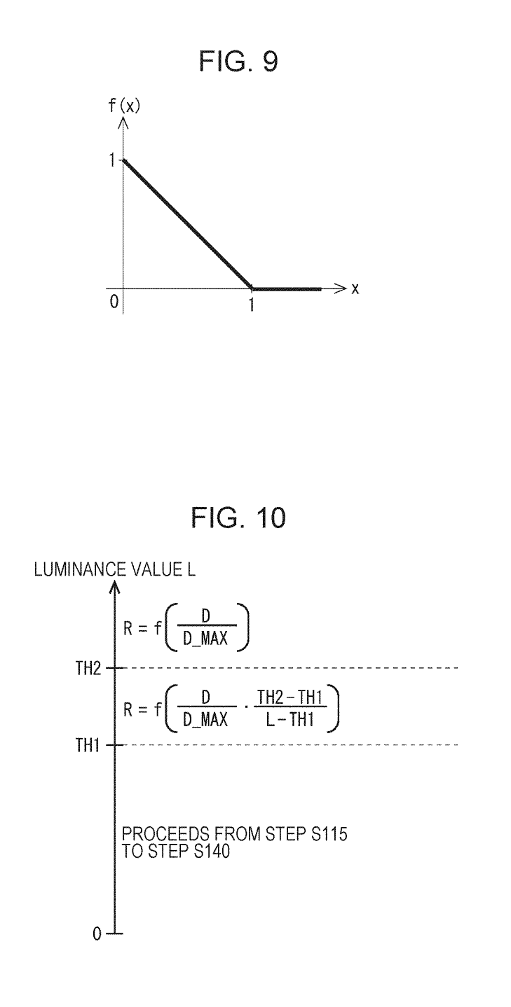

The function f(x) used for calculating the assumed mixing ratio R is a function that defines how the luminance value changes in the gradation area added by the glare correction processing. In the present embodiment, a function f(x) expressed by the following equation (3) is used for calculating the assumed mixing ratio R so as to add a gradation area in which the luminance value gradually decreases linearly from the high luminance pixel toward the surroundings (See FIG. 9).

$$\begin{matrix}[ Expression 5 ] & \\ \begin{matrix}f ( x ) = 1 - x ( when 0 \leq x \leq 1 ) \\ f ( x ) = 0 ( when 1 < x )\end{matrix} \} & ( 3 )\end{matrix}$$

Note that the luminance value L and the distance D are equal to or larger than zero, and the values of the first threshold value TH1, the second threshold value TH2, and the variable D_MAX are positive values. As described above, the second threshold value TH2 is a value larger than the first threshold value TH1. Further, at the time of the processing of step S120 is performed, the luminance value L is a value larger than the first threshold value TH1. From the above, the argument x of the function f(x) has a value of equal to or larger than zero.

By the way, in step S120, when the luminance value L is less than the second threshold value TH2, the value of the argument x of the function f(x) becomes a value obtained by multiplying “(D/D_MAX)” by “(TH2−TH1)/(L−TH1)”. Since the value of “(TH2−TH1)/(L−TH1)” is larger than one when the luminance value L is less than the second threshold value TH2, by assigning the value obtained by multiplying “(D/D_MAX)” by “(TH2−TH1)/(L−TH1)” as the argument x of the function f(x), the value of the assumed mixing ratio R becomes a lower value as compared with the case where the luminance value L is equal to or larger than the second threshold value TH2.

As described above, in the processing of steps S115 to S120, as shown in FIG. 10, if the luminance value L of the search pixel is equal to or larger than the second threshold value TH2, the value of the assumed mixing ratio R is set to the value of the function f(D/D_MAX), if the luminance value L of the search pixel is larger than the first threshold value TH1 and less than the second threshold value TH2, the value of the assumed mixing ratio R is set to the value of the function f((D/D_MAX)·((TH2−TH1)/(L−TH1))), and if the luminance value L of the search pixel is less than or equal to the first threshold value TH1, the processing proceeds from step S115 to step S140.

After the assumed mixing ratio R is obtained in step S120, in step S125, it is determined whether or not the value of the product of the luminance value L and the assumed mixing ratio R is larger than the value of the variable L_MAX. As a result of the determination, if the value of the product of the luminance value L and the assumed mixing ratio R is larger than the value of the variable L_MAX, the processing proceeds to step S130. On the other hand, if the value of the product of the luminance value L and the assumed mixing ratio R is equal to or less than the value of the variable L_MAX, the processing proceeds to step S140.

In step S130, a value of the product of the luminance value L and the assumed mixing ratio R is assigned to the variable L_MAX, and the pixel value V of the search pixel is assigned to the variable V_RESa. The value of the assumed mixing ratio R is assigned to the variable R_RESa.

In step S140, one is added to the value of the variable SX. In step S145, it is determined whether or not the value of the variable SX is larger than the value of the variable D_MAX. As a result of the determination, if the value of the variable SX is larger than the value of the variable D_MAX, the processing proceeds to step S150. On the other hand, if the value of the variable SX is equal to or less than the value of the variable D_MAX, the processing returns to step S110.

In step S150, a negative value of the variable D_MAX is assigned to the value of the variable SX, and one is added to the value of the variable SY. In step S155, it is determined whether or not the value of the variable SY is larger than the value of the variable D_MAX. As a result of the determination, if the value of the variable SY is larger than the value of the variable D_MAX, the processing proceeds to step S160. On the other hand, if the value of the variable SY is equal to or less than the value of the variable D_MAX, the processing returns to step S110.

Note that the processing in steps S140 to S155 is processing in which the pixels included in the predetermined range centered on the target pixel are sequentially selected one by one as a search pixel to repeatedly execute the processing of steps S110 to S130.

In step S160, the value of the variable V_RESa is output as the pixel data V_RES and the value of the variable R_RESa is output as the mixing ratio data R_RES. By the way, the value of the product of the luminance value L and the assumed mixing ratio R corresponds to the luminance value of the target pixel (the target pixel after the glare correction processing) in the gradation area in a case where it is assumed that the luminance value of the target pixel based on the input image data Din is zero. By repeating the processing of steps S110 to S130 as described above, the pixel having the largest value of the product of the luminance value L and the assumed mixing ratio R among the pixels included in the predetermined range from the target pixel is detected as a high luminance pixel. In step S160, the data of the pixel value V of the high luminance pixel is output as the pixel data V_RES, and the data of the assumed mixing ratio R corresponding to the high luminance pixel is output as the mixing ratio data R_RES. As a result, the high luminance pixel search processing for one target pixel terminates.

Based on the pixel data V_RES and the mixing ratio data R_RES output from the high luminance pixel searching unit 126 to the pixel value mixing unit 128 through the high luminance search processing like above, the pixel value mixing unit 128 corrects the pixel data of the target pixel V_ORG, as described above (see the above equation (1)).

Note that the reason why the two threshold values (the first threshold value TH1 and the second threshold value TH2) are used in the high luminance pixel search processing is as follows. If only one threshold value is used, a gradation area is provided in a portion where pixels having luminance values larger than the threshold value exist, and a gradation area is not provided in a portion where only pixels having luminance values equal to or less than the threshold value exist. In this manner, the control whether or not to add a gradation area suddenly switches with a certain fixed luminance value as the boundary. Therefore, depending on an input image, there is a concern that the image after the glare correction processing gives a sense of discomfort to a viewer. In this regard, by using two threshold values as in the present embodiment, it is possible to add a gradation area in which the area size changes smoothly in accordance with the luminance value of the high luminance pixel from a gradation area of a relatively wide area to a gradation area of zero width (that is, a state in which a gradation area is not added). Thereby, giving a sense of discomfort to a viewer due to the addition of the gradation area is suppressed.

### 5. Effect

According to the present embodiment, when a high luminance pixel is present around a pixel (target pixel), the pixel value of the target pixel is corrected according to the distance from the high luminance pixel and the pixel value of the high luminance pixel by the glare correction processing. In other words, when there is a pixel with a remarkably high luminance value (high luminance pixel), a gradation area such that the luminance value gradually decreases from the high luminance pixel is added around the high luminance pixel.

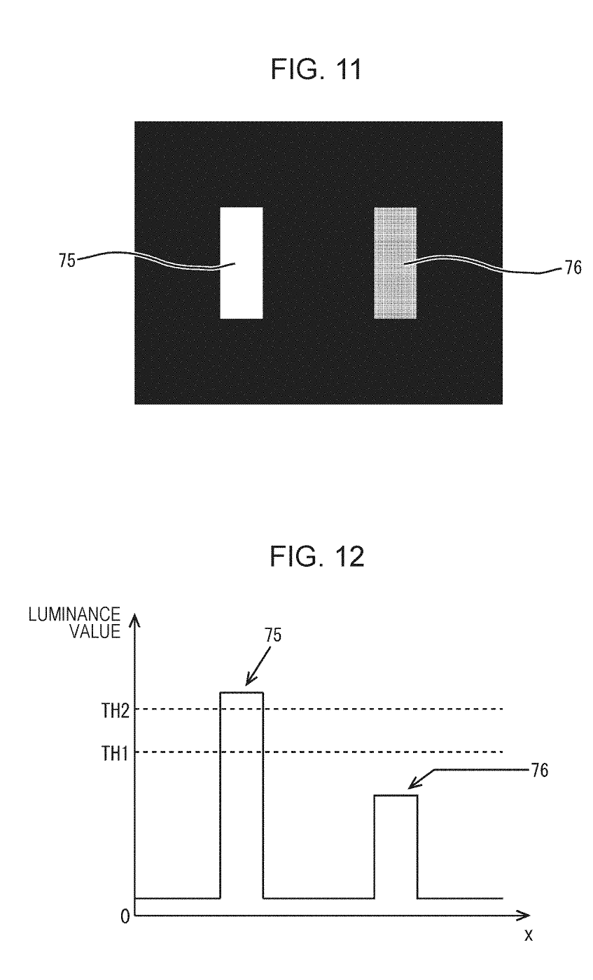

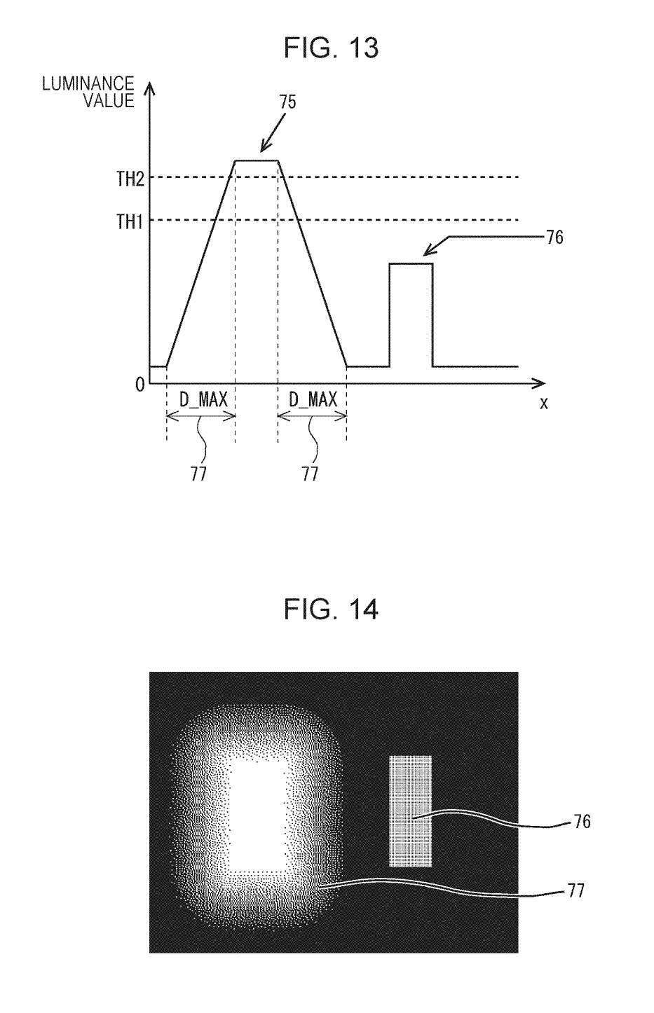

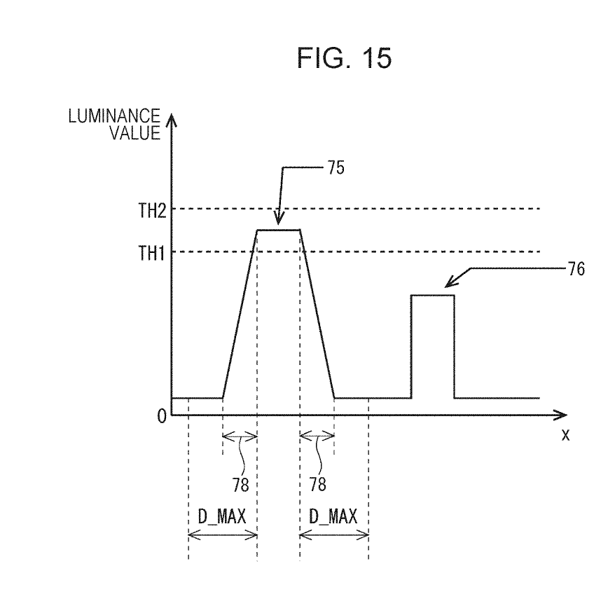

For example, it is assumed that an input image (an image represented by input image data Din sent from the outside) is an image as shown in FIG. 11. Regarding this input image, a remarkably bright area (hereinafter referred to as “high luminance area”) 75 and a somewhat bright area (hereinafter referred to as “medium luminance area”) 76 are included in a dark background. FIG. 12 is a graph showing a luminance value of each pixel on a certain scanning line in a horizontal direction passing through the high luminance area 75 and the medium luminance area 76 in FIG. 11. As shown in FIG. 12, it is assumed that “a luminance value in the high luminance area 75 is a value equal to or larger than the second threshold value TH2, and a luminance value in the medium luminance area 76 is a value larger than zero and equal to or less than the first threshold value TH1”. In such a case, according to the present embodiment, by the glare correction processing, as shown in FIG. 13, an area whose distance from the high luminance area 75 is equal to or less than a distance corresponding to the variable D_MAX is set to a gradation area 77 and a luminance value of the pixel in the gradation area 77 is raised higher than the original luminance value. At that time, luminance values are increased for pixels closer to the high luminance area 75. In this way, as shown in FIG. 14, an image to which the gradation area 77 is added is displayed on the display unit 510. Since the luminance value in the medium luminance area 76 is a value equal to or less than the first threshold value TH1, as shown in FIG. 14, no gradation area is added around the medium luminance area 76. In this example, the luminance value in the high luminance area 75 is a value equal to or larger than the second threshold value TH2. However, if the luminance value in the high luminance area 75 is equal to or larger than the first threshold value TH1 and less than the second threshold value TH2, and if the value of “((TH2−TH1)/(L−TH1)” is two, as shown in FIG. 15, an area in which a distance from the high luminance area 75 is equal to or less than a half of the distance corresponding to the variable D_MAX is set to the gradation area 78.

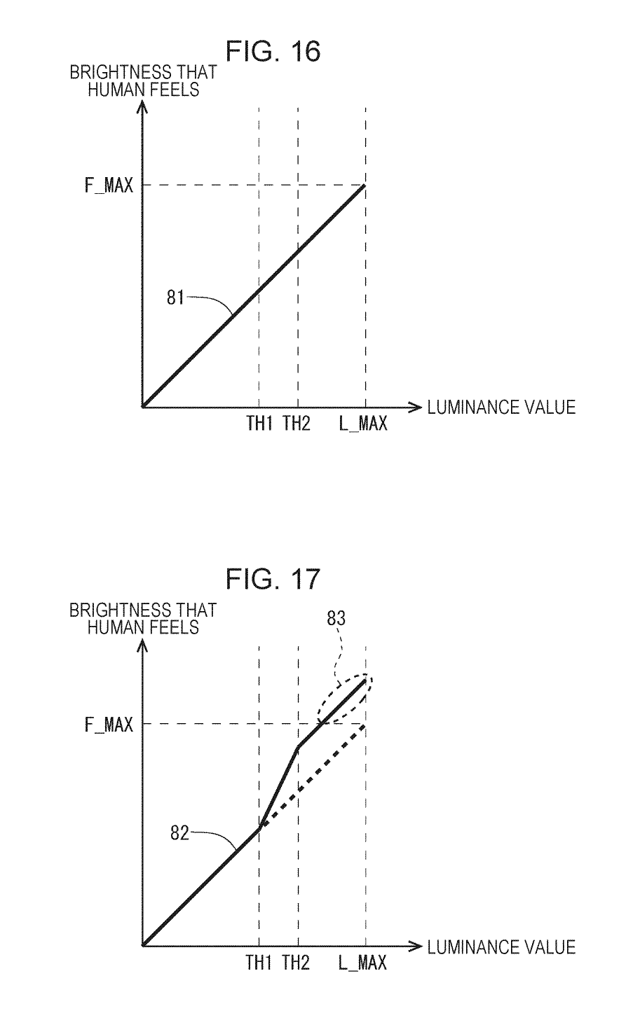

FIG. 16 is a graph showing “correspondence between a luminance value of an input image and a brightness that a human feels” in a case where the glare correction processing is not performed. FIG. 17 is a graph showing “correspondence between a luminance value of an input image and a brightness that a human feels” in a case where the glare correction processing is performed. Here, attention is paid to pixels of the locally bright portion existing in the dark background. As can be seen from FIG. 16, when the glare correction processing is not performed, the brightness that a human feels becomes strong as the luminance value of the input image increases, like a straight line indicated by a reference numeral 81. The maximum value of the brightness that a human feels in this case, is set to F_MAX. Even when the glare correction processing is performed, the brightness that a human feels becomes stronger as the luminance value of the input image increases, like a straight line indicated by a reference numeral 82 in FIG. 17. However, in a case where the glare correction processing is performed, as can be seen from FIG. 17, when the luminance value of the input image becomes a value equal to or larger than the first threshold value TH1, a human feels brighter as compared with a case where the glare correction processing is not performed. In detail, in a case where the luminance value of the input image is equal to or larger than the first threshold value TH1 and less than the second threshold value TH2, as the luminance value of the input image is higher, the difference becomes larger between the brightness that a human feels when the glare correction processing is not performed and the brightness that a human feels when the glare correction processing is performed. When the luminance value of the input image becomes a value equal to or larger than the second threshold value TH2, the brightness that a human feels gradually increases as shown in FIG. 17 as the luminance value increases. In a portion indicated by a reference numeral 83 in FIG. 17, the strength that a human feels exceeds F_MAX described above.

As described above, according to the present embodiment, when a high luminance area is included in the input image, a human feels the brightness of the high luminance area stronger than before. That is, an upper limit of the dynamic range is increased in a pseudo manner. In addition, according to the present embodiment, the maximum light emitting luminance of the LED in the backlight 600 is the same as before. Therefore, the limitation on the performance of the LED (light emitting element) is imposed only by the same limitation as before, and no new limitation is imposed. Similarly, the limitation on the performance of the power supply is imposed only the same limitation as before, and no new limitation is imposed. As described above, according to the present embodiment, a liquid crystal display device capable of allowing a user to view images with a wider dynamic range than before can be realized regardless of performance limitations of a light emitting element and a power supply.

Further, according to the present embodiment, since the light emitting luminances of the plurality of LEDs are controlled independently by the local dimming processing, low power consumption can be achieved. In addition to increasing the upper limit of the dynamic range in a pseudo manner, it is also possible to lower the lower limit of the dynamic range by remarkably lowering the light emitting luminance of the LED in the low gradation portion.

### 6. Modification Example

Modification examples of the above embodiment will be described below.

### 6.1 First Modification Example

In the above embodiment, the local dimming processing is performed in which the screen is logically divided into a plurality of areas and the luminance of the light source is controlled for each area. However, the present disclosure is not limited to this, and even when processing of uniformly controlling the light emitting luminance of one or more light sources in the screen (this processing is simply referred to as “dimming processing” so as to distinguish the processing from the local dimming processing.) is performed, the above-described glare correction processing can be applied. According to the dimming processing, since the luminance of all the light sources is uniformly controlled regardless of positions of the light sources, such control is referred to as “zero dimensional (OD) dimming”. In the present modification example, a dimming processing unit corresponding to the local dimming processing unit 130 shown in FIG. 5 is provided in the display control circuit 100.

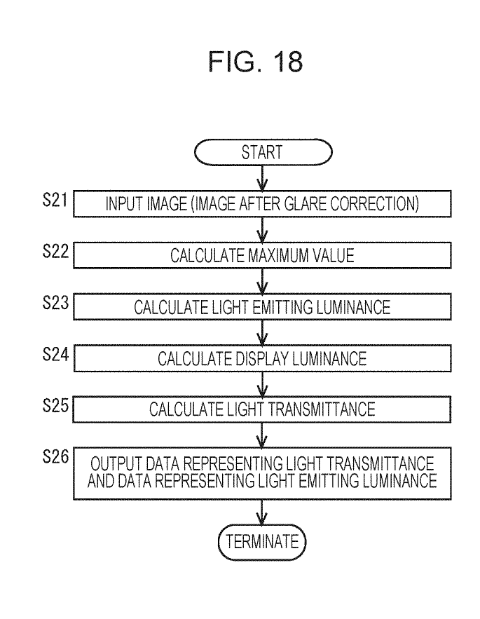

Here, referring to FIG. 18, an example of a procedure of the dimming processing for uniformly controlling the light emitting luminance of one or more light sources will be described. Note that in the present modification example, the dimming processing is performed for each color of R, G, and B. Further, it is assumed that “m and n are integers of equal to or larger than two”.

First, the image after the glare correction (glare correction data GD) is input to the dimming processing unit (step S21). (m×n) pieces of gradation value data are included in the glare correction data GD for one screen. Next, the dimming processing unit obtains the maximum value of the gradation value of the glare correction data GD (step S22). Next, based on the maximum value obtained in step S22, the dimming processing unit obtains the light emitting luminance which is a luminance at the time of the LED emits light (step S23). Next, based on the light emitting luminance obtained in step S23, the dimming processing unit obtains display luminance data BR representing the display luminance in (m×n) pieces of sub-pixels (step S24). The display luminance data BR represents a luminance of light incident on the (m×n) pieces of sub-pixels when all the LEDs of the target color emit light with the light emitting luminance obtained in step S23.

Next, the dimming processing unit obtains the light transmittance of the (m×n) pieces of the sub-pixels by dividing the luminance corresponding to the gradation values of (m×n) pieces of the sub-pixels included in the image after the glare correction by the (m×n) pieces of the display luminance included in the display luminance data BR (step S25). Lastly, the dimming processing unit outputs the digital video signal DV corresponding to the light transmittance obtained in step S25 and the light emitting luminance data BD for causing the LED to emit the light with the light emitting luminance obtained in step S23 (step S26).

Note that it is described on the premise that the backlight 600 is configured with the LED unit 60 including the red LED 60R, the green LED 60G, and the blue LED 60B. However, even when the backlight 600 is configured with a white LED, the dimming processing as described above can be performed. In this case, for example, after a Y image (luminance image) is generated based on the R image, the G image, and the B image, the processing of steps S22 to S24 may be performed on the Y image, and the processing of step S25 may be performed on a combination of each of the three color images and the Y image.

According to the present modification example, there are cases where it is possible to reduce the light emitting luminance of the LED by the dimming processing, so that low power consumption can be achieved. In addition to increasing the upper limit of the dynamic range in a pseudo manner, it is also possible to lower the lower limit of the dynamic range by remarkably lowering the light emitting luminance of the LED in the low gradation portion. Further, since the screen is not logically divided into a plurality of areas, it is possible to simplify the circuit used for various operations of the dimming processing as compared with the above embodiment.

### 6.2 Second Modification Example

In the above embodiment, a liquid crystal display device performing the local dimming processing is described as an example, and in the first modification example, a liquid crystal display device performing the dimming processing is described as an example. However, the present disclosure is not limited thereto. Hereinafter, an example in which the present disclosure is applied to a liquid crystal display device that does not perform the local dimming processing or the dimming processing will be described below as a second modification example. In the present modification example, since the local dimming processing and the dimming processing are not performed, the lower limit of the dynamic range cannot be lowered.

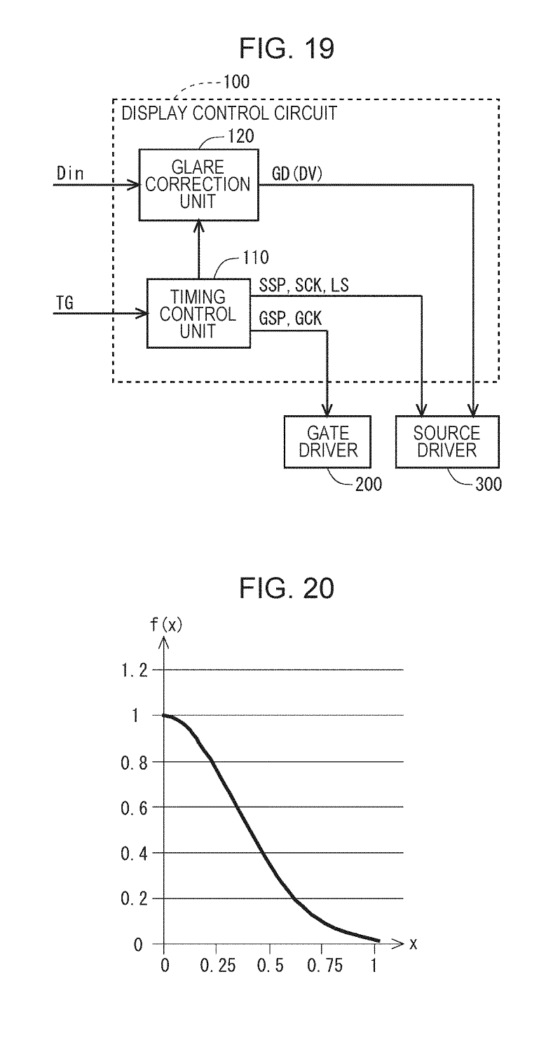

In the present modification example, a configuration of the display control circuit 100 is different from the above embodiment. FIG. 19 is a block diagram showing a configuration of a display control circuit 100 in the present modification example. The display control circuit 100 is configured with a timing control unit 110, and a glare correction unit 120. That is, unlike the above embodiment, the local dimming processing unit 130 (see FIG. 5) is not provided.

The timing control unit 110 receives the timing signal group TG sent from the outside, controls an operation of the glare correction unit 120, outputs the gate start pulse signal GSP and the gate clock signal GCK to the gate driver 200, and outputs the data start pulse signal SSP, the data clock signal SCK, and the latch strobe signal LS to the source driver 300.

The glare correction unit 120 performs glare correction processing on the input image data Din sent from the outside. Then, the glare correction unit 120 outputs the glare correction data GD, which is data after the glare correction processing, to a source driver 300 as the digital video signal DV.

Note that in the present modification example, the local dimming processing is not performed. That is, the control of light emitting luminance of the LED is not performed. Accordingly, there is no need to output the light emitting luminance data BD from the display control circuit 100 to the light source control unit 400 (see FIG. 2).

In the above configuration, by performing the same glare correction processing as in the above embodiment in the glare correction unit 120, it is possible to increase the upper limit of the dynamic range in a pseudo manner similar to the above embodiment. Thereby, a liquid crystal display device capable of allowing a user to view an image with a wider dynamic range than before can be realized regardless of performance limitations of a light emitting element or a power supply.

### 6.3 Third Modification Example

In the above embodiment, the function f(x) represented by the above expression (3) is used for calculating the assumed mixing ratio R. However, if the value of f(x) decreases as the value of argument x increases from zero to one, the expression representing the function f(x) is not limited to above expression (3). For example, a Gaussian function represented by the following equation (4) may be used as a function f(x) for calculating the assumed mixing ratio R.

$$\begin{matrix}[ Expression 6 ] & \\ f ( x ) = a \cdot exp \{ - \frac{{( x - b )}^{2}}{2 {c}^{2}} \} & ( 4 )\end{matrix}$$

Here, a, b, and c are constants that define a shape of a curve representing the function f(x). Note that expZ means e to the power Z.

FIG. 20 represents a graph of a function f(x) when “a=1, b=0, c=3” in the above expression (4). According to the present modification example, a gradation area is added such that the luminance value gradually decreases like a curve shown in FIG. 20, for example, from the high luminance pixel toward the surrounding.

### 6.4 Fourth Modification Example

In the above embodiment, two threshold values (the first threshold value TH1 and the second threshold value TH2) are used in the high luminance pixel search processing (see FIG. 8). However, the present disclosure is not limited to this, and it is also possible to adopt a configuration (the configuration of the present modification example) in which only one threshold value is used in the high luminance pixel search processing.

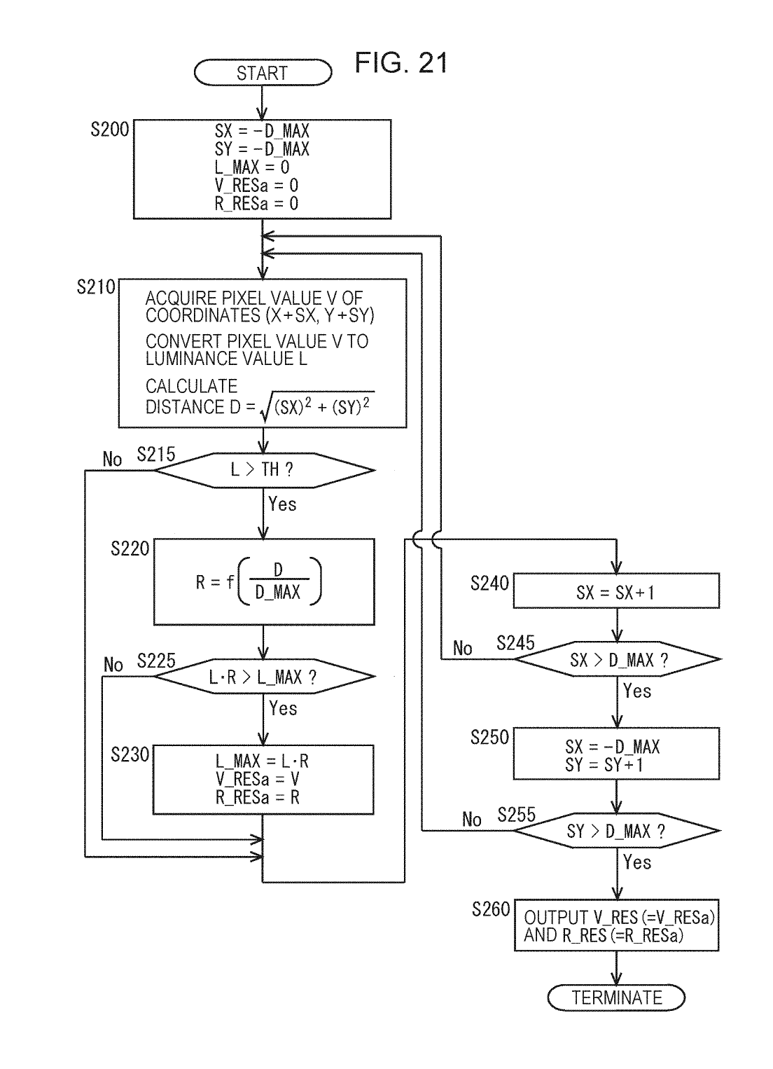

FIG. 21 is a flowchart showing a procedure of the high luminance pixel search processing in the present modification example. In steps S200 to S210 and steps S225 to S260 in the present modification example, the same processing as steps S100 to S110 and steps S125 to S160 in the embodiment (see FIG. 8) is performed. Therefore, only different points from the above embodiment will be described below.

In step S215 corresponding to step S115 in the above embodiment, it is determined whether or not the luminance value L obtained in step S210 is larger than the threshold value TH (the threshold value TH corresponds to the first threshold value TH1). As a result of the determination, if the luminance value L is larger than the threshold value TH, the processing proceeds to step S220. On the other hand, if the luminance value L is equal to or less than the threshold value TH, the processing proceeds to step S240.

In step S220 corresponding to step S120 in the above embodiment, a value of a function f(D/D_MAX) is assigned to the variable R. As described above, in the present modification example, if the luminance value L is larger than a certain predetermined threshold value TH, a value of the variable R (the assumed mixing ratio R) is determined without comparing other threshold values with the luminance value L (That is, regardless of the magnitude of the luminance value L).

According to the present modification example, the boundary portion between the area to which the gradation area is added and the area to which the gradation area is not added becomes more conspicuous as compared with the above embodiment. However, according to the present modification example, since it is sufficient to compare the luminance value L with only one threshold value, it is possible to simplify the circuit as compared with the above embodiment. In this way, it is possible to increase the upper limit of the dynamic range in a pseudo manner just by providing a relatively simple circuit.

### 6.5 Fifth Modification Example

As described above, in the high luminance pixel search processing, the luminance value L is compared with two threshold values in the above embodiment, and the luminance value L is compared with one threshold value in the fourth modification example. However, the present disclosure is not limited to this, and it is also possible to adopt a configuration (the configuration of the present modification example) in which the comparison between the luminance value L and the threshold value is not performed in the high luminance pixel search processing.

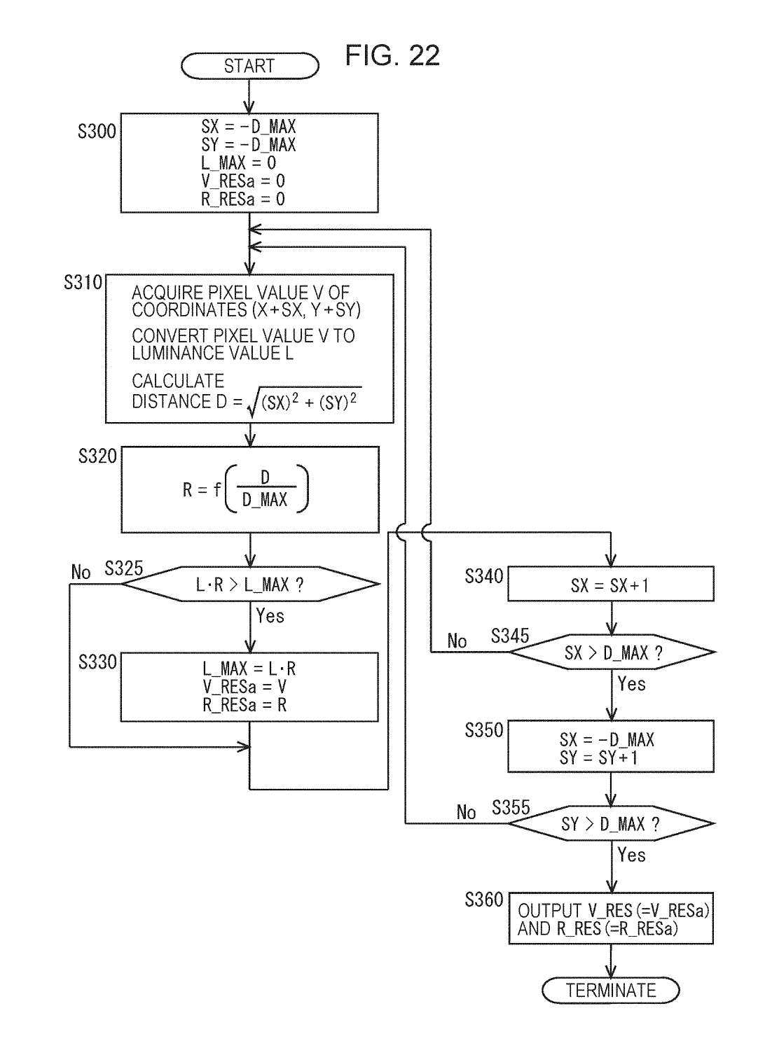

FIG. 22 is a flowchart showing a procedure of the high luminance pixel search processing in the present modification example. In steps S300 to S310 and steps S325 to S360 in the present modification example, the same processing as steps S100 to S110 and steps S125 to S160 in the embodiment (see FIG. 8) is performed. Therefore, only different points from the above embodiment will be described below.

In the present modification example, a step corresponding to step S115 in the above embodiment is not provided. Then, in step S320 corresponding to step S120 in the above embodiment, a value of a function f(D/D_MAX) is assigned to the variable R. As described above, in the present modification example, the value of the function f(D/D_MAX) is assigned to the variable R regardless of the magnitude of the luminance value L obtained in step S310.

According to the present modification example, a gradation area is added to every portion of the entire image. Therefore, there is a concern that the image quality is inferior as compared with the above-described embodiment and the fourth modification example. However, since there is no need to compare the luminance value L with the threshold value, it is possible to further simplify the circuit as compared with the fourth modification example. In this way, it is possible to increase the upper limit of the dynamic range in a pseudo manner just by providing a simple circuit.

### 7. Other

In the above embodiment (including modification examples), a liquid crystal display device is described as an example. However, the present disclosure is not limited thereto. The present disclosure can also be applied to an image display device (for example, an organic EL display device) other than a liquid crystal display device. In addition, the above embodiment (including modification examples) can also be implemented with various modifications without departing from the spirit of the present disclosure.

The present application claims the priority based on Japanese Patent Application No. 2016-216890, entitled “Image display device and image display method”, and filed on Nov. 7, 2016, the content of this Japanese application is incorporated herein by reference.

### REFERENCE SIGNS LIST

100 display control circuit
110 timing control unit
120 glare correction unit
122 line memory control unit
124 line memory
126 high luminance pixel searching unit
128 pixel value mixing unit
130 local dimming processing unit
Din input image data
GD glare correction data
R assumed mixing ratio
R_RES mixing ratio data
V_RES pixel data of a high luminance pixel
V_ORG pixel data of a target pixel

1. An image display device having a display unit including a plurality of pixels and displaying an image corresponding to input image data on the display unit, the device comprising:
a pixel value correction unit that corrects a pixel value of a pixel around a high luminance pixel so that a gradation area, in which a luminance value gradually decreases from the high luminance pixel toward a low luminance pixel, is provided; and
a display driving unit that drives the display unit based on the corrected pixel value by the pixel value correction unit.

2. The image display device according to claim 1,
wherein the pixel value correction unit sequentially selects all the pixels included in the display unit one by one as a target pixel, and corrects a pixel value of the target pixel according to a distance from the target pixel to the high luminance pixel and a pixel value of the high luminance pixel.

3. The image display device according to claim 2,
wherein the pixel value correction unit includes
a high luminance pixel searching unit for detecting, as a high luminance pixel, a pixel having a relatively high luminance value determined according to a predetermined determination criterion from among a plurality of pixels within a predetermined range centered on the target pixel based on the input image data, and outputting a mixing ratio for use in correcting the pixel value of the target pixel and a pixel value of the high luminance pixel based on the input image data, and
a pixel value mixing unit for correcting the pixel value of the target pixel by mixing the pixel value of the target pixel based on the input image data and the pixel value of the high luminance pixel output from the high luminance pixel searching unit according to the mixing ratio output from the high luminance pixel searching unit,
wherein the mixing ratio is set to a larger value as the distance from the target pixel to the high luminance pixel is shorter, and
wherein the pixel value mixing unit corrects the pixel value of the target pixel so that a contributory portion of the pixel value of the high luminance pixel output from the high luminance pixel searching unit increases as the mixing ratio output from the high luminance pixel searching unit is larger.

4. The image display device according to claim 3,
wherein the high luminance pixel searching unit
sequentially selects the plurality of pixels within the predetermined range centered on the target pixel one by one as a search pixel, obtains a luminance value of the search pixel based on a pixel value of a search pixel based on the input image data, and obtains an assumed mixing ratio which is a mixing ratio in a case where it is assumed that the search pixel is determined as a high luminance pixel, and
detects a search pixel, in which a product value of the luminance value and the assumed mixing ratio becomes the largest value, as a high luminance pixel, and outputs the assumed mixing ratio corresponding to the search pixel as a mixing ratio for use in correcting the pixel value of the target pixel.

5. The image display device according to claim 4,
wherein the high luminance pixel searching unit obtains the assumed mixing ratio by using a mixing ratio calculation function prepared in advance with a value corresponding to a distance from the target pixel to the search pixel as an argument.

6. The image display device according to claim 5,
wherein the mixing ratio calculation function is represented by the following expression:
f(x)=1−x (when 0≤x≤1)
f(x)=0 (when 1≤x) [Expression 7]
where x is a value determined according to the distance from the target pixel to the search pixel.

7. The image display device according to claim 5,
wherein the mixing ratio calculation function is represented by the following expression:
$$\begin{matrix}[ Expression 8 ] & \\ f ( x ) = a \cdot exp \{ - \frac{{( x - b )}^{2}}{2 {c}^{2}} \} & \end{matrix}$$
where x is a value determined according to the distance from the target pixel to the search pixel, and a, b, and c are constants defining a shape of a curve representing the mixing ratio calculation function.

8. The image display device according to claim 4,
wherein the high luminance pixel searching unit obtains the assumed mixing ratio corresponding to the search pixel, only for the search pixels in which a luminance value is larger than a predetermined first threshold value.

9. The image display device according to claim 8,
wherein the high luminance pixel searching unit obtains the assumed mixing ratio according to the following expression, in accordance with a magnitude relationship between a predetermined second threshold value set to a value larger than the first threshold value and the luminance value of the search pixel, by using a mixing ratio calculation function f prepared in advance with a value determined according to a distance from the target pixel to the search pixel as an argument:
$$\begin{matrix}[ Expression 9 ] & \\ R = f ( \frac{D}{D\_MAX} ) ( when L \geq TH 2 ) & \\ R = f ( \frac{D}{D\_MAX} \cdot \frac{TH 2 - TH 1}{L - TH 1} ) ( when L < TH 2 ) & \end{matrix}$$
where R is the assumed mixing ratio, D is the distance from the target pixel to the search pixel, D_MAX is the maximum distance from the target pixel to a pixel that can be a search pixel, L is the luminance value of the search pixel, TH1 is the first threshold value, and TH2 is the second threshold value.

10. The image display device according to claim 8,
wherein the high luminance pixel searching unit obtains the assumed mixing ratio according to the following expression by using a mixing ratio calculation function f prepared in advance with a value determined according to a distance from the target pixel to the search pixel as an argument:
$$\begin{matrix}[ Expression 10 ] & \\ R = f ( \frac{D}{D\_MAX} ) ( when L \geq TH 2 ) & \end{matrix}$$
where R is the assumed mixing ratio, D is the distance from the target pixel to the search pixel, and D_MAX is the maximum distance from the target pixel to a pixel that can be a search pixel.

11. The image display device according to claim 4,
wherein the high luminance pixel searching unit obtains the assumed mixing ratio corresponding to each search pixel, for all the search pixels.

12. The image display device according to claim 1, further comprising:
a backlight having one or more light sources; and
a light source control unit that controls light emitting luminance of the one or more light sources,
wherein the light source control unit uniformly controls the light emitting luminance of the one or more light sources.

13. The image display device according to claim 1, further comprising:
a backlight having a plurality of light sources; and
a light source control unit that controls light emitting luminance of the plurality of light sources,
wherein the display unit is logically divided into a plurality of areas,
wherein each of the light sources is provided so as to correspond to any of the plurality of areas, and
wherein the light source control unit controls the light emitting luminance of the plurality of light sources for each area.

14. An image display method for displaying an image corresponding to input image data on a display unit including a plurality of pixels, the method comprising:
a pixel value correction step of correcting a pixel value of a pixel around a high luminance pixel to a value larger than a value based on the input image data so that a gradation area, in which a luminance value gradually decreases from the high luminance pixel toward a low luminance pixel, is provided; and
a display driving step of driving the display unit based on the corrected pixel value obtained in the pixel value correction step.
